(19) United States
(12) Patent Application Publication
(10) Pub. No.: US 2011/0033156 A1
(43) Pub. Date: Feb. 10, 2011

(54) Microstructured Fiber End

(76) Inventors: Jasbinder S. Sanghera, Ashburn, VA (US); Catalin M. Florea, Washington, DC (US); Ishwar D. Aggarwal, Fairfax Station, VA (US); Leslie Brandon Shaw, Woodbridge, VA (US); Lynda E. Busse, Alexandria, VA (US); Frederic H. Kung, Alexandria, VA (US)

Correspondence Address: Rebecca L. Forman;US Naval Research Laboratory, 4555 Overlook Ave, SW, Washington, DC, 20375, US

(21) Appl. No.: 12/851,377

(22) Filed: Aug. 5, 2010

Related U.S. Application Data
(60) Provisional application No. 61/232,022, filed on Aug. 7, 2009.

(51) Int. Cl. G02B 6/36; B29D 11/00

(52) U.S. Cl. 385/76; 216/24; 264/2.7

(57) ABSTRACT

An optical fiber having microstructured terminal end suitable for reducing Fresnel losses. In an exemplary embodiment, the microstructured surface includes a plurality of protrusions, recesses or combinations thereof that effectively and incrementally change the refractive index of the terminal end of the optical fiber such that the refractive index is gradually drawn closer to the refractive index value of the surrounding environmental medium.

This application is a non-provisional of U.S. Provisional Application No. 61/232,022, filed Aug. 7, 2009, the entire disclosure of which is hereby incorporated by reference in its entirety as if set forth fully herein.

### BACKGROUND

Typical near-infrared optical fibers which transmit light in the 0.8 to 1.6 micron range, such as those used in telecommunication systems, are fabricated from silica. Silica glasses are low-index materials having a refractive index of about 1.4 to about 1.5, which is near the 1.0 refractive index of air. Consequently, light passes through the glass-air interface without significant transmission loss, frequently referred to as Fresnel losses. Typically near infrared silica optical fibers have a transmission loss of about 4% loss per interface.

For the mid infrared regions and beyond (e.g. beyond 2 μm), optical fibers are typically composed of high index materials, such as chalcogenide glasses. These materials have high refractive indices of about 2.4 to about 2.8; the light consequently experiences high losses of about 17% to about 22% loss per interface when it enters and exits the fiber to and from air, respectively.

A number of different techniques have been developed to reduce transmission loss at optical fiber ends. For example, the change in refractive index at the ends of optical fibers can be reduced by applying an anti-reflective coating on the fiber tip. These coatings take advantage of the interference phenomenon which occurs in thin films and therefore can be designed to enhance the light transmission within a defined wavelength band where constructive interference takes place so as to reduce the reflection on the fiber end. While these coatings are fairly robust in the case of silica-based glasses, they have limitations for infrared materials. In the case of chalcogenide glasses, which cannot be subjected to very high temperatures, the coatings have poor adhesion to the chalcogenide glass and are sensitive to humidity. Additionally, these coatings damage easily under intense laser radiation. Consequently, there is a need for reducing surface reflection losses using a more robust approach and to enable higher laser power transmission.

In the field of bulk optics, transmission losses are reduced by incorporating a plurality of sub-wavelength surface (SWS) relief structures on a window surface so as to induce the refractive index to gradually vary from the refractive index value of air to the refractive index value of the window material. These SWS relief structures are generally a collection of identical objects, such as graded cones or depressions that generate strong diffraction or interference effects. The distances between the objects and the dimensions of the objects themselves are typically smaller than the wavelength of light with which they are designed to interact.

Little has been done, however, to create similar SWS on the ends of optical fibers. Most of the work has been focused on obtaining surface-enhanced fiber sensors by coating materials onto a fiber surface, such as that taught by C. Viets, W. Hill, “Comparison of fibre-optic SERS sensors with differently prepared tips”, Sens. Actuators B 51 92 (1998). In one study, G. Kostovski, D. J. White, A. Mitchell, M. W. Austin, P. R. Stoddart, “Nanoimprinting on Optical Fiber End Faces for Chemical Sensing”, Proc. SPIE 7004, 70042H (2008), which teaches imprinting a silica based fiber optic chemical sensor with a nanopattern in order to optimize the interaction of light at the surface of the fiber to optimize performance, the nanopattern is imprinted on a polymer that coats the end of the fiber, not directly on the end of the fiber itself. This type of patterning may be described as indirect patterning since the pattern is not imprinted directly onto the fiber material. The polymer would also not be suitable to withstand high intensity infrared laser power. Furthermore, the investigated nanopattern would not be able to effectively reduce transmission losses particularly in the infrared region, since the nanopattern structures are extremely shallow.

Therefore there is a need to develop improved optical fibers, particularly optical fibers for the transmission of light in the infrared range that have a direct microstructured end surface to reduce Fresnel losses.

### BRIEF SUMMARY

The present invention is directed to an optical fiber. In a first aspect, the optical fiber is adapted to transmit light over at least a portion of an infrared range and has an elongated body and a terminal end. A plurality of microstructures selected from the group consisting of protrusions, recesses and combinations thereof are defined on a surface of the terminal end.

In a second aspect, the optical fiber has an elongated body and terminal end. A plurality of microstructures selected from the group consisting of protrusions, recesses and combinations thereof are defined on a surface of the terminal end. In this embodiment, an effective incremental change in the refractive index value along a length of the microstructures extending from the terminal end to an apex of said microstructure is about 2 to about 3.

In a third aspect, the invention is directed to a method for enhancing the transmission of light at the interface of an optical fiber. The method involves forming a plurality of microstructures directly onto the terminal end of an optical fiber, wherein the microstructures incrementally change the refractive index of the terminal end of the fiber, drawing it closer to the refractive index of the environmental medium surrounding the terminal end of the optical fiber.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a schematic diagram of a cross-section of an exemplary optical fiber.

FIG. 2(a) is a schematic diagram of a cross-section of periodic pointed top pyramidal microstructures having a width of 1.5 μm at the base and a height of 1 μm.

FIG. 2(b) is a schematic diagram of a cross-section of periodic flat top pyramidal microstructures having a height of 0.72 μm, a width of 0.46 μm at the base, a width of 0.18 μm at the top and a spacing between the pyramidal structures of 0.45 μm.

FIG. 2(c) is a schematic diagram of a cross-section of quintic profile microstructures having a period of about 1.5 μm.

FIG. 2(d) is a schematic diagram of a cross-section of quintic profile microstructures having a period of about 2.4 μm.

FIG. 2(e) is a schematic diagram of a cross-section of quintic profile microstructures having a period of about 3.4 μm.

FIG. 3 is a schematic diagram of a cross-section of an exemplary transparent cover including side walls and a cap member connected to a distal end of a sheath.

FIG. 4 is a schematic diagram of a cross-section of another exemplary transparent cover connected to a distal end of a sheath.

FIG. 5 is a schematic diagram of a cross-section of another exemplary transparent cover connected to an inner surface of a sheath.

FIG. 6 is a schematic diagram of a cross-section of an exemplary optical fiber including a sheath, optic and transparent cover.

FIG. 7 is a schematic diagram of a cross-section of an exemplary optical fiber wherein the transparent cover functions as an optic lens.

FIG. 8(a) is a profile SEM image of a nickel template which can be used to pattern a terminal end of a fiber.

FIG. 8(b) is an overview SEM image of the motheye array formed on a terminal end of an As₂S₃ optical fiber fabricated using the template of FIG. 8(a).

FIG. 8(c) is a FIB image of the core area of the fiber of FIG. 8(b).

FIG. 9(a) is a profile SEM image of another nickel template which can be used to pattern a terminal end of a fiber.

FIG. 9(b) is a FIB image showing details of the nickel template shown in FIG. 9(a).

FIG. 9(c) is an SEM image of the motheye array formed on a terminal end of an As₂S₃ optical fiber core area that was fabricated using the template of FIGS. 9(a)-9(b).

FIG. 10(a) is a profile SEM image of a silicon wafer template.

FIG. 10(b) is an overview SEM image of the motheye array formed on a terminal end of an As₂S₃ optical fiber fabricated using the template of FIG. 10(a).

FIG. 10(c) is a SEM image of the core area of the fiber of FIG. 10(b).

FIG. 10(d) is an FIB image showing details of the core area of the fiber of FIG. 10(c).

FIG. 11(a) is a schematic diagram of a side view of a stamping chamber.

FIG. 11(b) is an overhead schematic diagram of the stamping chamber of FIG. 11(a).

FIG. 12(a) is a graph of fiber transmission as a function of wavelength comparing the measured experimental results obtained using the template of FIG. 10(a) in comparison to a model based on the actual motheye array microstructure profile (depth 849 nm).

FIG. 12(b) is a graph of fiber transmission as a function of wavelength comparing the measured experimental results obtained using the template of FIG. 10(a) in comparison to a model based on an idealization of the motheye array microstructure profile (depth 905 nm).

FIG. 13(a) is an SEM image of an acid-etched, rough-side of a silicon wafer template.

FIG. 13(b) is a microstructure array formed on the terminal end of an As₂S₃ optical fiber using the template of FIG. 13(a).

FIG. 13(c) is a close-up of the SEM image of FIG. 13(b).

FIG. 14(a) is an SEM image of a microstructure motheye array formed on the terminal end of an As₂S₃ optical fiber.

FIG. 14(b) is a close-up of the SEM image of FIG. 14(a).

FIG. 15 is an SEM image of a silicon wafer template with an inverted, negative of a random microstructure array.

FIG. 16(a) is an SEM image of a microstructure motheye array formed on the terminal end of an As₂Se₃ bulk glass.

FIG. 16(b) is a graph of transmission as a function of wavelength showing a comparison between the transmission before and after the motheye array was formed on the As₂Se₃ bulk glass of FIG. 16(a).

FIG. 17 is a graph of transmission as a function of wavelength showing the improvement in transmission of an optical fiber.

### DETAILED DESCRIPTION

For illustrative purposes, the principles of the present invention are described by referencing various exemplary embodiments. Although certain embodiments of the invention are specifically described herein, one of ordinary skill in the art will readily recognize that the same principles are equally applicable to, and can be employed in other systems and methods. Before explaining the disclosed embodiments of the present invention in detail, it is to be understood that the invention is not limited in its application to the details of any particular embodiment shown. Additionally, the terminology used herein is for the purpose of description and not of limitation. Furthermore, although certain methods are described with reference to steps that are presented herein in a certain order, in many instances, these steps may be performed in any order as may be appreciated by one skilled in the art; the novel method is therefore not limited to the particular arrangement of steps disclosed herein.

It must be noted that as used herein and in the appended claims, the singular forms “a”, “an”, and “the” include plural references unless the context clearly dictates otherwise. Furthermore, the terms “a” (or “an”), “one or more” and “at least one” can be used interchangeably herein. The terms “comprising”, “including”, “having” and “constructed from” can also be used interchangeably.

For purposes of the present invention, “chalcogenide glass,” as used herein refers to a vitreous material composed of one or more chalcogen elements, i.e. Group VI elements of the Periodic Table. Exemplary chalcogen elements may include sulfur, selenium, tellurium, or mixtures thereof. The addition of other elements such as germanium, arsenic, antimony or combinations thereof, facilitates glass formation. One or more dopants, such as gallium, rare earth elements, halogen elements and/or transition metals, may be added to the chalcogenide glass to enhance the optical properties of the fiber. Exemplary rare earth element dopants may include optically active elements, such as terbium, praseodymium, neodymium, erbium, cerium, dysprosium, holmium, thulium, ytterbium, or mixtures thereof, or non-optically active rare earth elements such as lanthanum, gadolinium, or mixtures thereof. Additionally, the chalcogenide glass may optionally further include one or more glass stabilizers, such as one or more halides, such as chlorine, bromine, fluorine and iodine. In another embodiment, the chalcogen elements may be mixed with one or more Group IV and/or Group V elements to form conventional compound glasses.

For purposes of the present invention, “halide glass,” as used herein refers to a vitreous material comprising one or more halogens, i.e. Group VII elements of the Periodic Table. Exemplary halogen elements may include fluorine, chlorine, bromine, iodine, or combinations thereof. Preferably, the halide glass is a fluoride glass, such as ZrF₄, BaF₂, LaF₃, AlF₃ NaF (ZBLAN) ZrF₄, BaF₂, LaF₃, AlF₃ (ZBLA), ZrF₄, BaF₂, LaF₃ (ZBL), BeF₂, and others. One or more dopants, such as gallium, indium, alkali elements, alkaline earth elements, rare earth elements, halogens and/or transition metals, may be added to the halide glass to enhance the optical properties of the fiber. Exemplary rare earth element dopants may include optically active elements, such as terbium, praseodymium, neodymium, erbium, cerium, dysprosium, holmium, thulium, ytterbium, or mixtures thereof, or non-optically active elements such as lanthanum, gadolinium, or their mixtures.

For purposes of the present invention, “microstructures” as used herein refers to a plurality of periodic or randomly arranged micron sized or nano sized structures, such as protrusions, depressions or combinations thereof; the term “microstructured surface” refers to a surface on which the microstructures are formed. Exemplary microstructures may be a collection of protrusions or depressions having identical or varying geometric configurations and dimensions, wherein the selected geometry of, dimensions of and spacing between the structures are designed to facilitate, and preferably optimize, the transmission of light at the terminal end of an optical fiber. When formed directly on an end of an optical fiber, the microstructures incrementally change the refractive index at the terminal end of an optical fiber, gradually drawing it closer to the refractive index of the environmental medium surrounding the terminal end of the optical fiber.

For purposes of the present invention, “motheye array” refers to a plurality of microstructures that are periodically arranged in a two dimensional array, such as a plurality of rows and columns.

For purposes of the present invention, “multi-clad” or “multi-cladding,” as used herein refers to a fiber having two or more claddings, including, but not limited to, double-clad and triple-clad optical fibers.

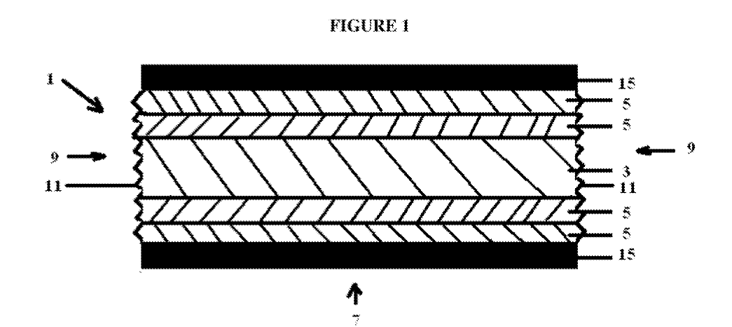

The present invention is directed to optical fibers having an antireflective microstructured end surface adapted to reduce Fresnel losses and methods for forming microstructures on the end of an optical fiber. As shown in the exemplary embodiment of FIG. 1, optical fiber 1 has an elongated body 7 and two opposing terminal ends 9, wherein microstructures 11 are defined on a surface of at least one terminal end 9. Microstructured terminal end 9 is designed to reduce Fresnel losses over a broad range of wavelengths, particularly over the infrared region, by changing the refractive index of optical fiber 1 at the fiber end, so as to gradually draw the refractive index of the terminal end 9 closer to the optical index of a surrounding environmental medium. The gradual change in the refractive index enhances the optical properties of fiber 1 by reducing the transmission loss at the interface of terminal end 9. In an exemplary embodiment, fiber 1 may further include a transparent cover 13 and/or any other optic 27 that encloses and protects the microstructured terminal end 9 while still enabling the transmission and handling of light. The resultant optical fiber 1 may be used to transmit light in any wavelength, particularly in the infrared ranges, and may be used for a wide variety of optical applications, such as imaging, optical sensors, laser technology, medical treatment and material processing.

As shown in FIG. 1, elongated body 7 of optical fiber 1 is defined by a core 3 and one or more surrounding claddings 5. Core 3 and cladding 5 of fiber 1 may be constructed from any suitable material. In an exemplary embodiment, core 3 and one or more claddings 5 are constructed from a high index material that enables the transmission of light in the infrared spectrum, preferably over a wavelength of about 1 μm to about 18 μm, more preferably over a mid-infrared wavelength of about 2 μm to about 5 μm or a long-infrared wavelength range of about 8 μm to about 12 μm. Exemplary materials may include chalcogenide glasses or halide glasses, such as fluoride glasses. Other exemplary glass optical fibers 1 may include silica fibers, silicate fibers, aluminate fibers, phosphate fibers, germanate fibers, tellurite fibers, bismuthate fibers, and antimonate fibers, wherein core 3 and cladding 5 may be constructed from silica, silicate, aluminate, phosphate, germanate, tellurite, bismuthate, or antimonite.

In another embodiment, optical fiber 1 may be selected from a polymer fiber, single crystal fiber, polycrystalline fiber and photonic crystal fiber, wherein cladding 5 is composed of a periodic or non-periodic array of capillaries or another phase that reduces the effective refractive index. These glass fibers, including the chalcogenide glass fibers and halide glass fibers, polymer fibers and crystal fibers are capable of transmitting in regions of about 0.2 μm to about 18 μm wavelength range. The specific regions of transmission in the infrared are dependent upon the material composition and length of optical fiber 1.

In an alternative embodiment, core 3 and one or more claddings 5 are constructed from materials suitable for enabling transmission of visible light or any other desired wavelength ranges. In one embodiment, the chemical composition of core 3 and/or one or more claddings 5 are different from one another such that the refractive index of each cladding decreases the further away the cladding 5 is positioned relative to core 3. For example, the material used to construct an inner first cladding may have a lower refractive index than core 3, and an outer second cladding may have a lower refractive index than first cladding disposed about core 3. This variation in refractive indices may be achieved by varying the molar ratios of the glass compounds of the core 3 and each subsequent cladding 5 and/or by using different glass systems in fabricating core 3 and claddings 5.

Additionally, core 3 and one or more claddings 5 may have any shape, dimension, structure or configuration suitable for enabling the transmission of light or enhancing the optical properties of optical fiber 1. In one embodiment, core 3 and one or more claddings 5 may be substantially solid throughout their cross-section so as to have no or minimal cavities or openings. Alternatively, core 3 may be substantially solid surrounded by a region comprising a plurality of longitudinal channels or openings arranged to direct light into the solid center. One or more claddings 5 may also have a region comprising a plurality of longitudinal channels or openings oriented parallel to the length of optical fiber 1 that establishes a photonic band gap sufficient to channel light towards core 3.

Optical fiber 1 may be constructed as a single-clad fiber. Alternatively, optical fiber 1 may be constructed as a multi-clad optical fiber, having two or more or three or more cladding layers. The outer cladding layers have a lower refractive index than the antecedent cladding and core, thereby stripping light from the antecedent cladding and trapping light from scattering from the core. This variation in refractive index may be achieved by varying the molar ratios of the glass compositions used to fabricate core 3 and claddings 5, by using different glass systems in fabricating core 3 and claddings 5, by incorporating longitudinal channels or openings in one or more claddings 5 or combinations thereof. Such multi-clad optical fibers 1 may therefore be used in a laser, wherein the second cladding allows pump light to be launched into the first cladding and become absorbed by core 3.

Optionally, fiber 1 may further include a protective sheath 15, such as a ferrule, fiber connector or other sleeve structure, disposed about the outermost cladding to facilitate handling. In one embodiment, sheath 15 may be a standard or modified fiber connector such as, but not limited to, industry standard FC, ST or SMA connectors. Protective sheath 15 may be constructed from any suitable materials, including plastics, such as, polyvinyl chloride, Hytrel® polyether ether ketone, or Teflon® or metals, such as braided stainless steel (either braided or interlocking), or may be configured as a furcation tubing. In an exemplary embodiment, protective sheath 15 is a furcation tubing having an outer tube, for abrasion resistance, an inner tube, for crush and kink resistance, and a fibrous layer between the tubes as a strengthening member. In one embodiment, sheath 15 may be constructed as a hydrophobic or hydrophilic polymeric material coating. Exemplary polymeric materials may include low density polyethylene, polydimethylsiloxane, polyacrylate or combinations thereof. In another embodiment the protective sheath 15 may be a thin layer of metal suitable for soldering the outermost cladding 5 to a metal ferrule or any other type of supporting device.

As shown in FIG. 1, optical fiber body 7 further comprises two opposing terminal ends 9. A plurality of microstructures 11 is formed directly on a surface of one or both terminal ends 9. In one embodiment, the microstructures 11 may be formed on and positioned throughout the entire surface area of terminal end 9. Alternatively, microstructures 11 may be selectively formed on an end face of core 1 and/or one or more select claddings 5. Additionally, the position of microstructures 11 at one terminal end 9 of optical fiber body 7 may be different or the same as the microstructures 11 positioned on the opposite terminal end 9.

Microstructures 11 may be a plurality of protrusions that are raised with respect to a surface of terminal end 9, a plurality of cavities or depressions that are recessed with respect to a surface of terminal end 9, or combinations thereof. The selected geometry of, dimension of and spacing between these microstructures 11 are designed to facilitate, and preferably optimize, the transmission of light at the terminal end of optical fiber 1. Exemplary structural configurations of these protrusions and depressions may include pyramids having a pointed or flat top, cones, semi-circular domes, tapered structures having a multi-faceted apex, such as a hexagonal apex, cones of quintic profiles, sinusoidal-shaped domes, sigmoid profiles, similar shaped profiles or combinations thereof. The exterior surface of microstructures 11 may be smooth, graded, otherwise textured or shaped, or any combination thereof, in order to further enhance light transmission at terminal end 9. When positioned on an end of an optical fiber 1, these microstructures 11 incrementally change the refractive index value at terminal end 9, gradually drawing the refractive index value closer to the refractive index of the surrounding environmental medium.

In an exemplary embodiment, the effective change in the refractive index experienced by the light entering an optical fiber, such as an As₂S₃ fiber, over the length of the microstructure 11 in a direction extending out from terminal end 9 to the apex of microstructure 11 is from about 1.0 to about 3.0, preferably, about 1.0 to about 2.0 and more preferably about 1 to about 1.8. For example, the refractive index value of an optical fiber 1, such as an optical fiber having a refractive index of about 2 to about 3, or an As₂S₃ fiber having a refractive index of about 2.4, incrementally changes to the refractive index value of a surrounding medium, such as air which has a refractive index value of about 1.0. This change is the effective change in the refractive index of an optical fiber 1 relative to the refractive index of a surrounding external medium in which optical fiber 1 is intended to be operated. The refractive index preferably changes in a quintic fashion along length of the microstructure as described in literature by H. W. Southwell, “Pyramid-array surface-relief structures producing antireflection index matching on optical surfaces”, JOSA A 8 549 (1991), incorporated herein by reference. In an alternative embodiment, the change in the refractive index value may have a linear, curved, parabolic, complex or other configuration. Templates or shims used to make the microstructures may be designed using Rigorous Coupled-Wave Analysis (RCWA), a second order approach to the effective medium theory or by other suitable methods.

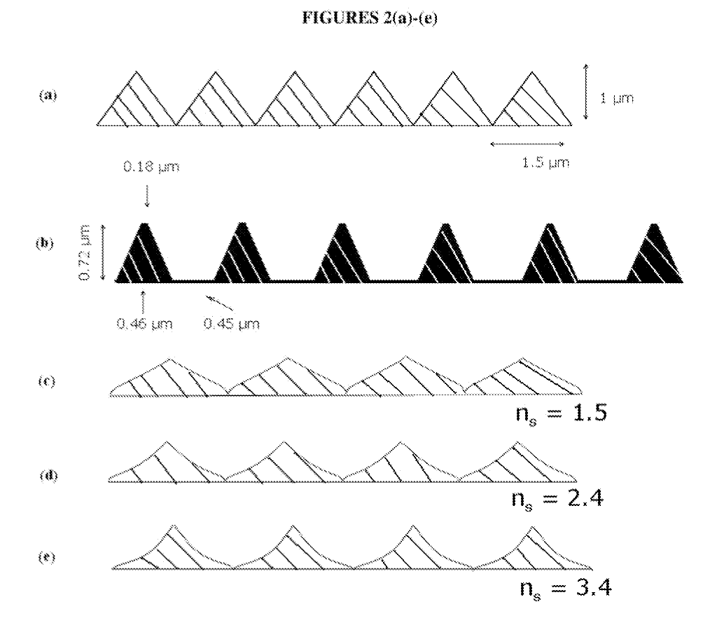

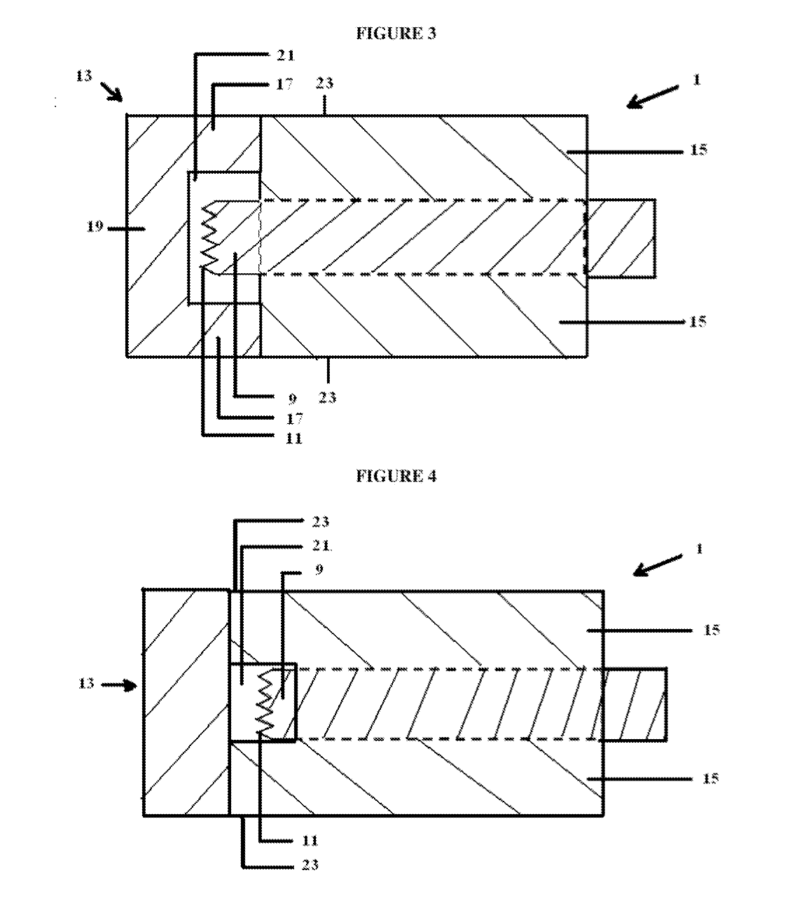

In one embodiment shown in FIGS. 2(a)-(e), microstructures 11 are a plurality of structures that are periodically arranged along a surface of terminal end 9. The microstructures 11 may be a collection of identical structures that are periodically arranged in a two dimensional array, referred to herein as a motheye array. Exemplary periodic two dimensional arrays include a plurality of rows and columns, and hexagonal packing structures. The period of a row or column of microstructures 11 is up to about and including λ, preferably up to about and including λ/2n, or preferably from about λ/2 to about λ.

The height or depth of the elements of the microstructure is on the order of about λ/2 to about several multiples of λ, preferably from about λ/2 to about 10λ and, more preferably, from about λ/2 to about 2λ. λ is the wavelength of transmitted light and n is the index of refraction of the optical fiber material, i.e. the material used to fabricate the core and/or cladding depending upon the position of microstructure 11. In an exemplary embodiment, microstructures 11 directly formed on terminal end 9 of an As₂S₃ fiber used for transmissions in the region of about 4 microns have a height or depth of about 2 μm and a period of about 0.83 μm.

The height or depth of microstructures 11 and the spacing between two or more microstructures 11 are adapted to enhance transmission of light over the near-infrared, mid-infrared and long infrared bands. In one embodiment, the height or depth and the spacing of microstructures 11 are selected to optimize transmission of light over the infrared region at wavelengths of about 1 μm to about 18 μm, particularly over a short wavelength infrared region of from about 1 μm to about 2 μm, over a mid-infrared region having wavelengths of about 2 μm to about 5 μm or over a long-infrared region having wavelengths of about 8 μm to about 12 μm. Preferably, an aspect ratio of the height or depth-to-period of microstructures 11 is about n. For example, the preferred height or depth-to-period ratio for an As₂Se₃ optical fiber operating in the 8-12 microns wavelength range would be 2.8.

In an exemplary embodiment, optical fiber 1 includes a motheye array comprising a collection of graded or smooth cones formed on terminal end 9 of an infrared optical fiber 1. The dimensions of and the spacing between microstructures 11 are adapted to enhance transmission of light in the mid-infrared region of about 2 μm to about 5 μm or in the long-infrared region of about 8 μm to about 12 μm. In one embodiment, the diameter of the base of the cones may be about 1-2 microns for applications in the long-infrared range. Core 3 and/or cladding 5 of the optical fiber 1 are constructed from, or preferably consist essentially of, one or more suitable chalcogenide glasses, such as As₂Se₃ or As₂S₃.

Alternatively, microstructures 11 may be a plurality of periodically arranged structures, wherein two or more structures have different geometric configurations and/or dimensions.

In an exemplary embodiment, microstructures 11 are a plurality of structures randomly arranged along a surface of terminal end 9. These structures may be identical to one another. Alternatively, two or more structures may have varying geometric dimensions. In an exemplary embodiment, two or more microstructures 11 have varying geometric dimensions wherein the height or depth of the microstructures 11 may vary over a range of about 100 nm to about 2 μm and wherein two or more microstructures 11 are separated by a distance within the range of about 50 nm to about 800 nm. In an exemplary embodiment, the height or depth of microstructures 11 and the spacing between microstructures 11 are adapted to enhance transmission of light over the infrared region, particularly over an infrared range of about 1 μm to about 18 μm, more preferably, over a range a near-infrared region of about 1 μm to 2 μm, over a mid-infrared region of about 2 μm to about 5 μm or over a long-infrared region of about 8 μm to about 12 μm.

In an exemplary embodiment, optical fiber 1 includes a random microstructure array comprising a plurality of cones of varying heights or depths formed on the terminal end 9 of an infrared optical fiber 1. The dimensions of and the spacing between the microstructures are adapted to enhance transmission of light in the mid-infrared region of about 2 μm to about 5 μm or in the long-infrared region of about 8 μm to about 12 μm. In one instance, the diameter of the base of the cones may be about 1 μm for applications in the long-infrared range. Core 3 and/or cladding 5 of the optical fiber 1 is constructed from, or preferably, consists essentially of, one or more suitable chalcogenide glasses, such as As₂Se₃.

In another embodiment, terminal end 9 of optical fiber 1 can also be patterned with a single microstructure or a plurality of microstructures 11 arranged to further function as a beam shaping tool and/or otherwise as a light manipulation device. For example, in one embodiment, a microprism with the ability to steer a light beam at a given angle can be directly embossed on terminal end 9. In another embodiment, microstructures 11 are directly formed on terminal end 9 of optical fiber 1 having a size, shape, structure and arrangement adapted for beam shaping and/or light manipulation, wherein the end surface of terminal end 9 is configured as an optical lens having any suitable shape, such as a concave curvature, convex curvature, a graded configuration, or other complex shapes or combinations thereof, to facilitate or enhance beam shaping or other light manipulation applications. For example, in one embodiment, a plurality of microstructures 11 can be directly embossed on terminal end 9 which is at the same time modified to have a curved shape such as to form a lens.

Because the microstructures 11 formed on the terminal end 9 are delicate, small structures, optical fiber 1 may optionally include a transparent cover 13 that functions like a window that encloses the microstructured surface so as to protect microstructures 11 from environmental factors, such as mechanical damage due to physical contact and abrasion, contamination from impurities, and other influences of the surrounding ambient medium. Transparent cover 13 may allow for light transmission and manipulation in a spectral range of interest. Alternatively, optical fiber 1 can include any suitable optic 27 that allows for light transmission and manipulation in a spectral range of interest. In another embodiment, transparent cover 13 may be constructed from an optic 27. Exemplary optics 27 can include conventional grin or graded lenses, attenuators, polarizers, prisms or any other suitable optic. By way of example, transparent cover 13 prevents dust particles from interacting with microstructures 11, which could impair optical performance of or physically damage the microstructured surface.

Transparent cover 13 may be constructed from any suitable transparent material that enables the transmission of light in the spectral range of interest and also protects microstructured terminal ends 9 from the surrounding environment. Exemplary materials may include glasses, such as but not limited to silica, BaO—Ga₂O₃—GeO₂ glasses (BGG glasses) or germanate glasses; ceramics, such as but not limited to spinel, sapphire, AION, ZnS, ZnSe, SnS, SnSe, germanium, silicon; or glass. Furthermore, transparent cover 13 may be coated with one or more materials, preferably an antireflective material, to further enhance the optical properties of fiber 1. In one embodiment, transparent cover 13 is a ceramic or glass-ceramic that can be sintered, ground and polished to specifications. In one embodiment, the protective window 13 is constructed from a thin piece of polished magnesium aluminate spinel ceramic about 1 mm thick that enables transmission up to about 5 um in the infrared spectrum. Other suitable window materials for transmission of particular wavelengths are known to skilled persons and may be employed herein.

As shown in the embodiment of FIG. 3, transparent cover 13 forms a chamber with sheath 15 and terminal end 9 that surrounds and encloses microstructures 11. Transparent cover 13 may be attached to a flexible or rigid sheath 15, preferably a ferrule or fiber connector, configured to surround and house at least a terminal end 9 of fiber 1. As shown in FIG. 3, transparent cover 13 has a cylindrical side wall 17 connected at one end to the sheath 15 of optical fiber 1. In one embodiment, cylindrical side wall 17 may be part of transparent cover 13, may be part of sheath 15 or may be an external artifact. Transparent cover 13 includes a cap member 19 positioned opposite to and spaced apart from microstructured terminal end 9. Cap member 19 may have any suitable shape or configuration, including a planar surface, a concave surface, a convex surface, or a domed or otherwise curved surface. In an exemplary embodiment, cap member 19 maybe a lens or other optic that focuses the transmitted light. Cylindrical side walls 17 and cap member 19 together define a chamber with sheath 15 and terminal end 9, forming a central cavity 21 that surrounds microstructures 9. Side walls 17 and cap member 19 are separated and spaced apart from terminal end 9 and microstructures 11. Preferably, transparent cover 13 forms a gas and water tight seal with sheath 15 so as to create a sealed optical cable. Therefore, the chamber defined by transparent cover 13, sheath 15 and terminal end 9 may be filled with any desired gaseous or liquid medium, so that terminal end 9 and microstructures 11 are bathed in the selected medium.

An exemplary embodiment, optical fiber 1 comprises two transparent covers 13 attached at opposite distal ends of two sheaths 15 positioned at opposite ends of the elongated fiber body 7 of optical fiber 1. In this embodiment, sheath 15 is a standard or modified fiber connector. Sheath 15 is positioned around the outer cladding of a chalcogenide glass-based optical fiber 1 that has a motheye array or random microstructure array formed opposing terminal ends 9. Transparent cover 13 is coupled to the distal end of sheath 15, so as to form a sealed chamber for containing microstructures 11.

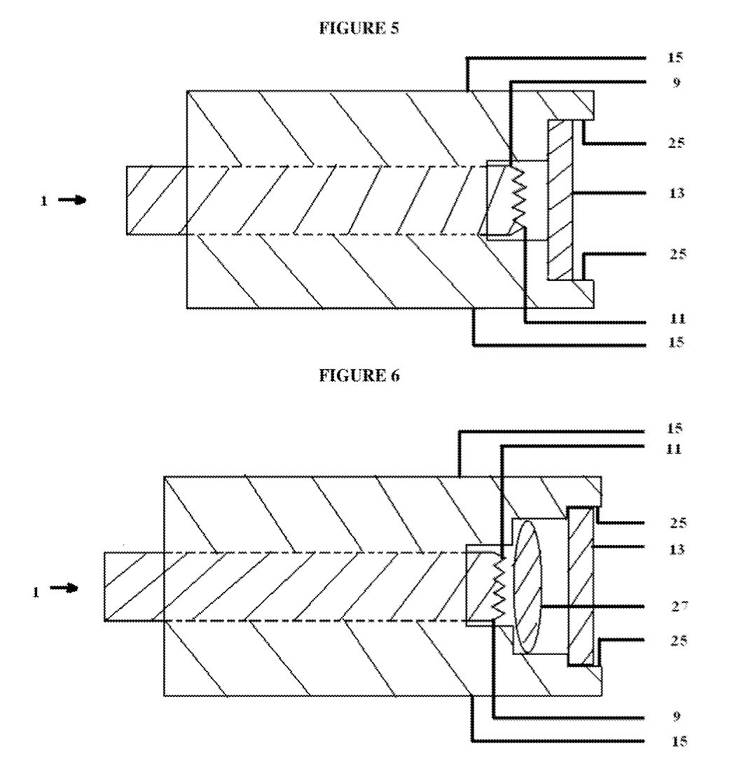

In an alternative embodiment of FIG. 4, the terminal end 9 is cabled inside and recessed within sheath 15. In this embodiment, transparent cover 13 may be a single structural member having an inner surface and an outer surface. The single structural member may be attached to an outer surface, inner surface or distal end of sheath 15 such that transparent cover 13 in conjunction with sheath 15 and terminal end 9 forms a chamber for enclosing and housing microstructures 11. In this embodiment, transparent cover 13 may have any suitable shape or configuration, preferably, the single member structure may have a planar or curved configuration, wherein its inner and outer surfaces have a planar, concave, convex, domed, otherwise curved surface or graded index structure. Additionally, inner and outer surfaces may have the same or different configurations. In an exemplary embodiment, the single structural member is a lens that focuses the transmitted light. As shown in FIG. 4, transparent cover 13 may be positioned on a distal end of sheath 15. Alternatively, transparent cover 13 may be attached to or fitted over an exterior surface 23 of sheath 15. Transparent cover 13 may also be positioned inside and attached to an inner surface 25 of sheath 15, as shown in FIG. 5. Preferably, transparent cover 13 forms a gas and watertight seal with sheath 15 so as to create a sealed optical cable. Therefore the chamber defined by transparent cover 13, sheath 15 and terminal end 9 may be filled with any gaseous or liquid medium, whereby terminal end 9 and microstructures 11 are bathed in the selected medium.

In an exemplary embodiment shown in FIG. 5, optical fiber 1 includes a transparent cover 13 constructed from a polished spinel ceramic about 1 mm in thickness and coated with an antireflective material that enables low-loss transmission up to about 5 um in the infrared range. The coating's function is to suppress reflection loss from the transparent cover 13. As shown, transparent cover 13 is a planar member sealed to an inner surface 25 positioned adjacent to a distal end of sheath 15. In this embodiment, microstructured terminal end 9 and microstructures 11 are recessed within sheath 15 and enclosed by transparent cover 13.

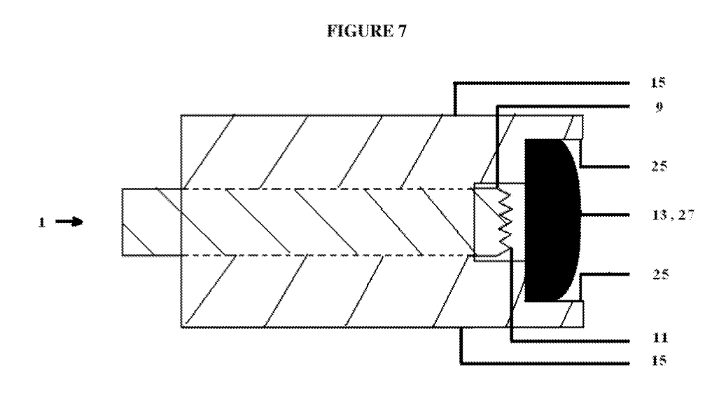

As shown in FIG. 6, optionally, optical fiber 1, transparent cover 13 or sheath 15 may further include any suitable optic 27 that allows for light transmission and/or manipulation in a spectral range of interest. Optic 27 may be used for collimation, beam shaping, otherwise manipulate light or combinations thereof. In one embodiment, optic 27 may protectively enclose the microstructured surface 11. Exemplary optics can be attenuators, polarizers, prisms, lenses, such as conventional, grin or graded lenses, or any other suitable optic. Optic 27 allows for light exiting the fiber to be collimated as needed while not adding significant transmission loss at termination end 9. Optic 27 may have any suitable shape, size or configuration, including a planar, concave, convex, domed, graded or any configuration. In an exemplary embodiment, optic 27 may have a complex shape to be used for beam shaping and collimation, such as a plano-convex lens. Optic 27 may be positioned between terminal end 9 and transparent cover 13, as shown in FIG. 6. Alternatively, transparent cover 13 may be positioned between terminal end 9 and optic 27. In the embodiment of FIG. 7 transparent cover 13 is and optic 27 are the same element, wherein transparent cover 13 is a plano-convex optic 27 configured as a lens. Optic 27 may be constructed from any suitable material and may have any suitable coating, including the same materials used to fabricate transparent cover 13. Other conventional coating materials known to skilled persons may also be employed.

In an exemplary embodiment, optical fiber 1 is a chalcogenide glass fiber with a motheye array or a random microstructure array formed on its two terminal ends 9. The chalcogenide glass fiber includes a sheath 15 configured as a standard or modified fiber connector. An optic 27, configured as a collimating lens is positioned within sheath 15, and a transparent cover 13 is positioned within a distal end of sheath 15, such that transparent cover 13, sheath 15 and terminal end 9 form a sealed chamber for containing microstructures 11 along with the optic lens.

Microstructured surface 11 of the present invention may be directly formed on terminal end 9 of optical fiber 1 using any suitable fabrication method, such as holographic lithography, reactive ion etching, ion milling or other surface transfer methods, such as embossing and stamping.

In an exemplary embodiment, microstructured fiber end 9 may be constructed using a stamping method that involves forming a template or shim having an inverse or negative pattern of microstructures 11 and using the template to imprint microstructure 11 directly onto terminal end 9. The templates can be made from any suitable material such as but not limited to microscopic glass tubes, silica glass, silicon wafers, nickel, vitreous carbon and black silicon, and it has a surface area sized to correspond to the size of terminal end 9 or a portion thereof. The inverse, negative pattern may be formed on the templates using any conventional methods, such as but not limited to photolithography and etching, thermal treatment and ion milling.

During the stamping process, terminal end 9 is exposed and placed in a chamber containing the fabricated template. Terminal end 9 is then placed in contact with the template for a predetermined duration effective to imprint the microstructure pattern directly onto terminal end 9. The template and/or terminal end 9 may be pre-heated to enable transfer of the microstructure pattern. Alternatively or in addition to pre-heating, heat may be applied to the template and/or terminal end 9 during stamping. In an exemplary embodiment, the stamping process may be performed in air or in the presence of other desired environmental media. Stamping may also be performed under vacuum to facilitate micropattern transfer. Optionally, nitrogen or other gases, such as helium or argon, may be introduced into the stamping chamber to create a dry environment or otherwise provide an optimum stamping environment. The stamping parameters, such as the stamping duration, the pressure applied between the template and terminal end 9, the applied heat, the chamber medium, the chamber temperature and the chamber humidity, are dependent on the microstructure pattern and characteristics of the optical fiber, such as the core-cladding ratio and glass transition temperature (T_{g}).

The fabricated optical fiber 1 of the present invention has substantially enhanced optical properties as a result of the microstructured terminal end 9. Namely, the microstructured terminal end 9 reduces transmission losses over a wide spectral band. This feature of the invention may be particularly advantageous for applications involving infrared transmission, wherein conventional methods for reducing Fresnel losses, such as applying an antireflective coating, were found to be problematic. Furthermore, antireflective coatings are typically only effective in reducing Fresnel losses over narrow spectral bands. The method of directly microstructuring the terminal fiber ends of the present invention provides greater environmental stability, enhances durability and improves optical transmission in comparison to methods of the prior art, as well as being applicable over wider spectral bands than antireflective coatings. Micropatterning also increases the surface resistance of the optical fiber end, thereby minimizing damage caused by high intensity light transmission, such as laser illumination.

The optical fiber and the micropatterning method of the present invention may be used for a wide variety of applications in the field of optics and semiconductors. It is envisioned that the invention may be used to enhance the efficiency of optical transmission for all optical fibers and consequently, improve any application that utilizes optical fibers. The invention may be particularly suitable for use in applications involving infrared transmissions and may be used to construct high-intensity infrared lasers and optical sensors that may be used in military applications, aeronautics, medical imaging, general imaging technology, and material processing.

Although the present application discussed the formation and use of microstructured surfaces in optical fibers, using the same fabrication methods, microstructure surfaces may also be formed on other optical surfaces, such as prisms in order to reduce transmission losses at interfaces between materials having different refractive indices. For example, motheye arrays including a plurality of graded or smooth cones may be formed on one or more surfaces of a prism. In an exemplary embodiment, the dimensions of the cones and the spacing between the cones are optimized as to enhance the transmission in the infrared range of about 1 μm to about 18 μm, preferably over a near-infrared region of about 1 μm to about 2 μm, over a mid-infrared region of about 2 μm to about 5 μm or over a long-infrared spectrum of about 8 μm to about 12 μm region. In an exemplary embodiment, the prism may be constructed from chalcogenide glass, such as As₂Se₃. Additionally, other prisms may be formed having any of the microstructures described herein.

### EXAMPLES

### Example 1

A study was conducted to investigate the effect of optical transmission efficiency as a result of forming motheye arrays directly on the terminal end surface of infrared multimode As₂S₃ optical fibers. The As₂S₃ optical fiber, having a core diameter of about 100 μm, a cladding diameter of about 180 μm transmitted light over a mid-infrared range of about 2 μm to about 5 μm.

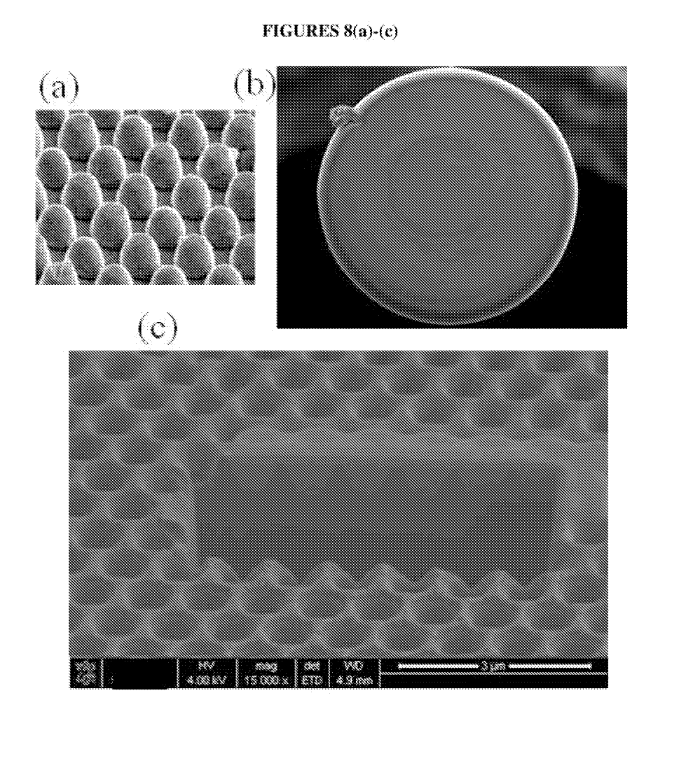

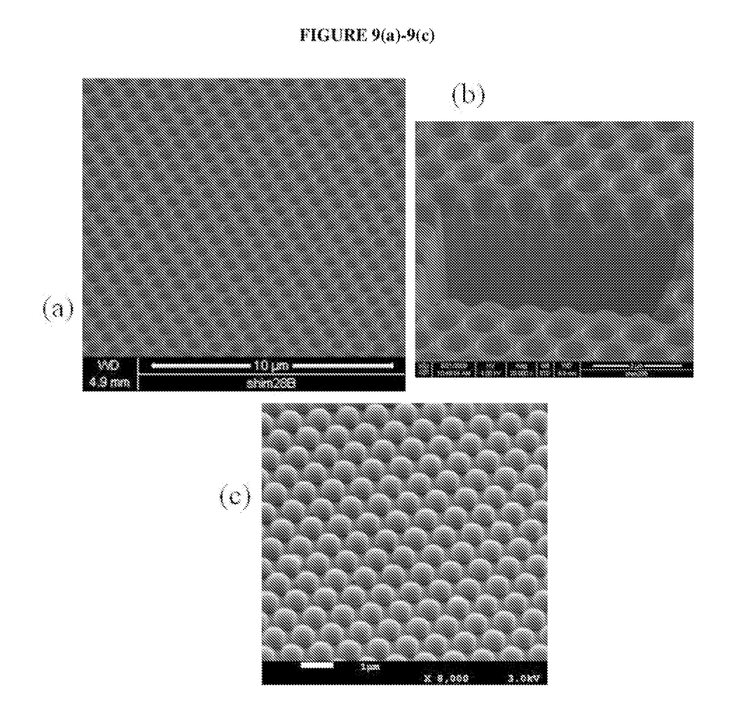

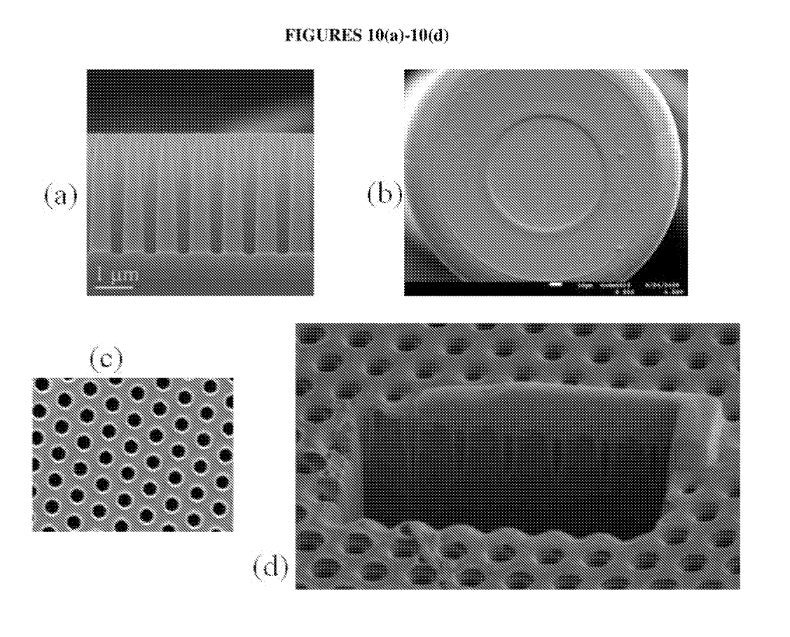

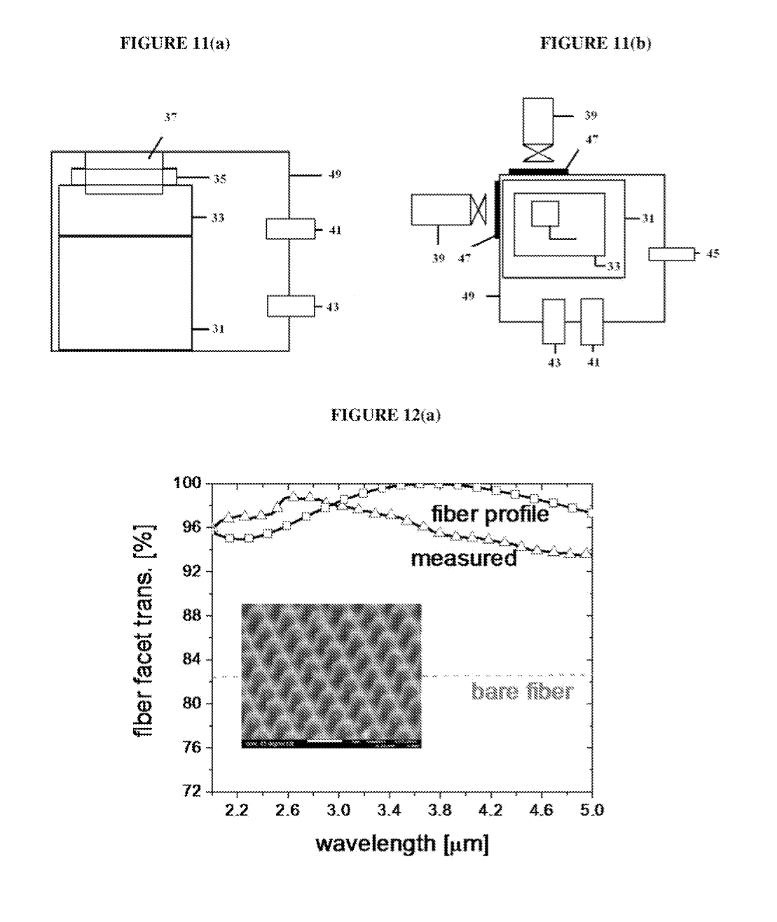

Three different micropatterns were evaluated in the study. Each microstructured array was imprinted onto the terminal end of three different As₂S₃ optical fibers using a direct stamping method. The method involved forming a template, which is known in the art as a shim, having the negative inverse microstructure pattern. The shims were designed using either TelAztec LLC's Rigorous Coupled-Wave Analysis (RCWA) software or a software using a second order approach to the effective medium theory. A first template, shown in FIG. 8(a), was fabricated from nickel and had a motheye array consisting of a collection of small protuberances elevated on the surface of the template and organized periodically in two dimensions. The protuberances were hexagonally-packed with a pitch of 800 nm and had a height of about 900 to 1000 nm. A second template, shown in FIGS. 9(a)-9(b), was fabricated from nickel and had a motheye array consisting of a collection of depressions or holes recessed in the surface of the template. The depressions were hexagonally-packed with a pitch of 800 nm and had a depth of about 800 nm. A third template, shown in FIG. 10(a), had a motheye array consisting of a collection of spikes that were hexagonally-packed with a pitch of about 730 nm and had a height of about 3000 nm.

Prior to stamping, the optical fibers were cleaved so as to form a terminal fiber end that was subsequently heated to a temperature of about 220° C. to about 240° C. The micropattern of each template was then directly imprinted onto each one of the fiber ends in turn. The stamping process involved placing the template in a stamping chamber 49 shown in FIGS. 11(a)-11(b). As shown, the stamping chamber 49 includes a stage 31 and a heater 33, on which template 35 is positioned. A viewport 37 allows for visualization of and, with the use of cameras 39, recordation of the stamping process. The stamping chamber 49 may further include a vacuum port 41, electrical feed port 43, gas port 45 and illumination port 47. While the pre-heated terminal end of the fiber was placed in contact with the template the other terminal end is fixed to a support. The template was pressed against the preheated terminal end for about 10 to about 30 seconds and then removed. Stamping was performed under a vacuum at a pressure of about 0.1 ton, and nitrogen gas was periodically flushed through the chamber to maintain a dry environmental condition.

The optical transmission of the fibers, both before and after stamping, was measured using either a single-wavelength source (HeNe laser at 3.39 μm) or an FTIR. Although slight changes in the facet angle between the core and cladding and bulging of the fiber end was observed as a result of the non-optimized stamping process, measurement errors arising from these artifacts were mitigated by using an integrating sphere for the measurement at 3.39 μm and correcting the FTIR trace accordingly. Furthermore, because one end of the fiber was always fixed during stamping, coupling to the fiber did not change during the process. Hence, the measured change in transmission can be attributed solely to the microstructure patterned terminal fiber end.

As shown in FIGS. 8(b)-8(c), a motheye array including a plurality of dome shaped depressions was formed on the terminal end of an As₂S₃ optical fiber using the first template. As shown in FIG. 9(c), a motheye array including a plurality of dome shaped protrusions was formed on the terminal end of an As₂S₃ optical fiber using the second template. As shown in FIGS. 10(b)-10(d), a motheye array including a plurality of spike shaped depressions was formed on the terminal end of an As₂S₃ optical fiber using the third template. The depth or height of the replicated features was measured to be about 900 to about 1300 nm, depending on the shim or template used.

Table 1 shows the transmission values obtained as a result of forming the aforementioned microstructure patterns on one end of the As₂S₃ optical fibers. In comparison to the original base transmission of the fiber end, estimated at about 83% given the 2.4 refractive index of the core of the As₂S₃ fiber used, all of the microstructure terminal ends improved transmission and reduced the Fresnel loss.

TABLE 1
Transmission values of the microstructured fiber ends

| Template | Transmission at 3.39 μm | Peak transmission* |
|---|---|---|
| 1 | 93.1% ± 1.9% | ~ 94.5% |
| 2 | 94.3% ± 1.6% | ~ 97.5% |
| 3 | 88.4% ± 1.4% | ~ 89.8% |

*transmission was typically maximum and flat across the 2.5-3.2 μm range

The data showed an abrupt decrease below wavelengths of 2.5 μm due to diffraction effects, as the wavelength of probing light starts to be comparable with the feature period. The data also showed a characteristic decrease toward longer wavelengths, due to the fact that the depth of the microstructured profile departs from optimum for longer and longer wavelengths.

The microstructured surface of the terminal fiber ends was analyzed using scanning electron microscopy (SEM). Focused ion-beam (FIB) milling, using gallium, was also used to mill out a portion of the microstructure surface to reveal the cross-section of the microstructures and to evaluate the depth of the microstructures. A platinum layer was deposited on top of the microstructure in order to protect the microstructure during evaluation.

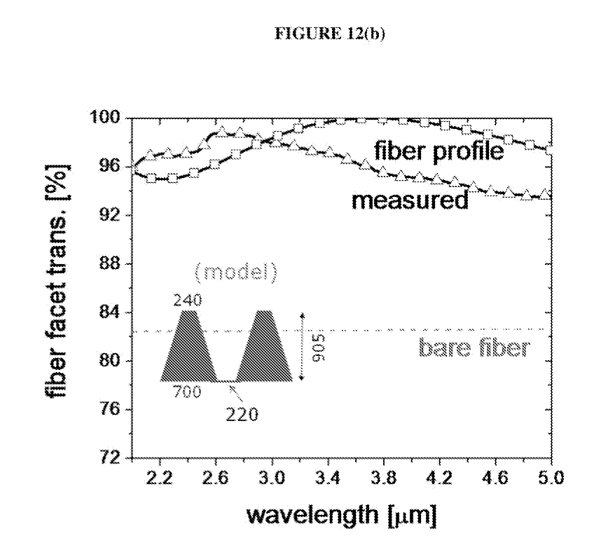

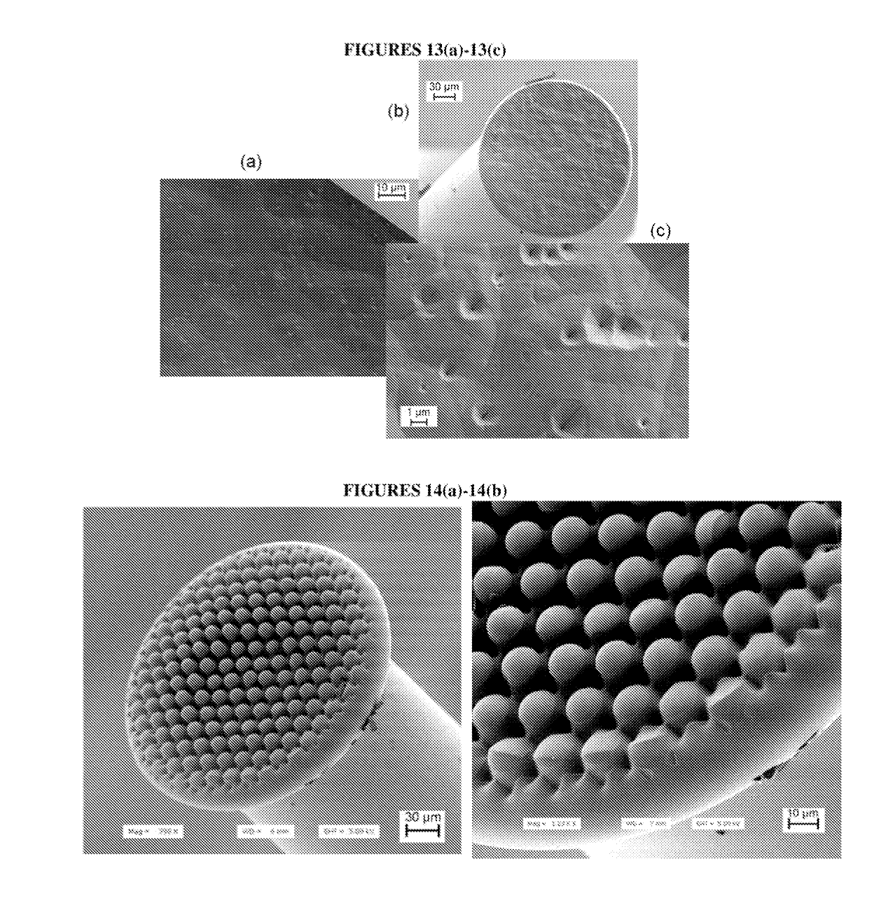

By way of example, FIGS. 12(a)-12(b) show a comparison of the measured experimental data with theoretical models obtained using second order EMT. The data collection at 3.39 μm was correlated with the FTIR traces in order to obtain accurate transmission data for the 2-5 μm range.

### Example 2

A plurality of microstructures was formed on the terminal end of an As₂S₃ infrared optical fiber using the same method described in Example 1. An inverted negative micropattern including a plurality of pyramids was acid-etched onto a silicon wafer template. The template was then used to imprint pyramid shaped depressions having a depth of less than about 200 nm, as illustrated in FIG. 13(a)-13(c), onto the terminal end of the As₂S₃ fiber.

### Example 3

A study was conducted to determine the depth to which a microstructure may be imprinted on the terminal end of an As₂S₃ infrared optical fiber using the same method described in Example 1. As shown in FIG. 14(a)-14(b), a two dimensional microstructure array having protuberances with a height of about 10 to about 20 μm was found to be readily feasible.

### Example 4

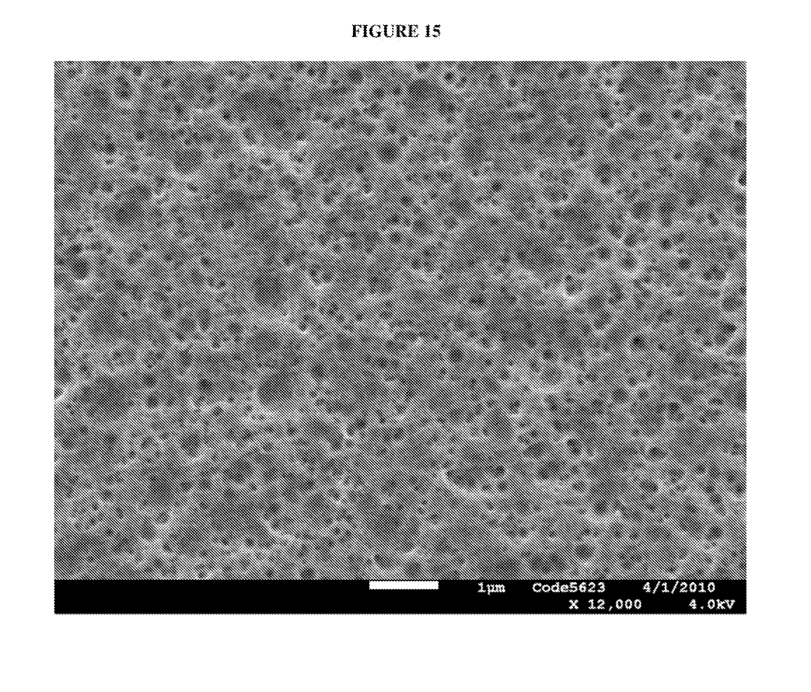

In an exemplary embodiment, a silicon wafer template for a microstructure array was fabricated by gold deposition and reactive ion etching. As shown in FIG. 15, the negative of the microstructure pattern imprinted on the silicon wafer template was a plurality of randomly arranged recesses of varying depths. The recesses were separated from one another by distances ranging from about 100 nm to about 500 nm. Upon stamping on the terminal end of an optical fiber, the inverse micropattern would be achieved.

### Example 5

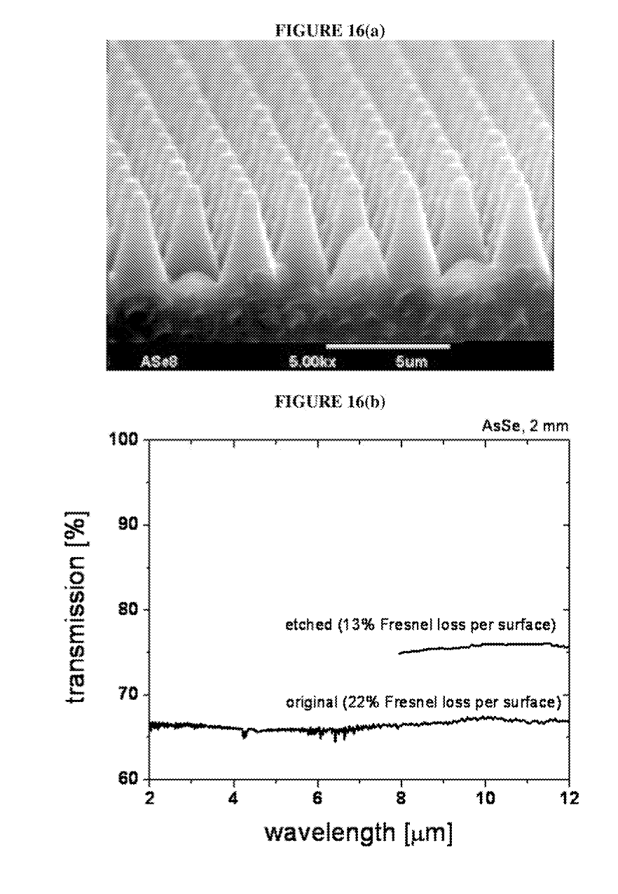

A preliminary study was also conducted to investigate the affect of motheye arrays on bulk pieces of As₂Se₃ glass. The As₂Se₃ glass wafers were prepared, cut to shape and custom polished. A motheye array comprising a plurality of graded cones, shown in FIG. 16(a), was formed on an exterior upper surface of the As₂Se₃ wafer.

The transmission light through the As₂Se₃ wafer was measured before and after the motheye array was imprinted on the chalcogenide glass wafer. A graph showing the change in transmission is shown in FIG. 16(b). The added microstructure array was found to increase transmission by about 13% in the mid-infrared range of about 8 to about 12 um, and the Fresnel loss was significantly reduced by 41%. Moreover, reduction in reflection was achieved over a very wide wavelength range, a significant improvement over traditional antireflection coatings which only reduce reflection over limited width spectral bands.

### Example 6 and Comparative Example A

A study was conducted to determine the durability of an As₂S₃ optical fiber with a motheye array formed on its terminal end in comparison to an As₂S₃ optical fiber having no microstructure formed on its terminal end and to an As₂S₃ optical fiber having a traditional antireflective coating on its terminal end. Each of the fibers was illuminated with a high power density of about 10 GW/cm² using a laser at 1.55 μm. Subsequently, the terminal ends of the fibers were examined. The motheye array was found to tolerate very high laser power density and sustained no damage. The As₂S₃ having no coating and no motheye array also did not sustain any damage. By comparison, the As₂S₃ fiber coated with an antireflective material sustained damage.

### Example 7

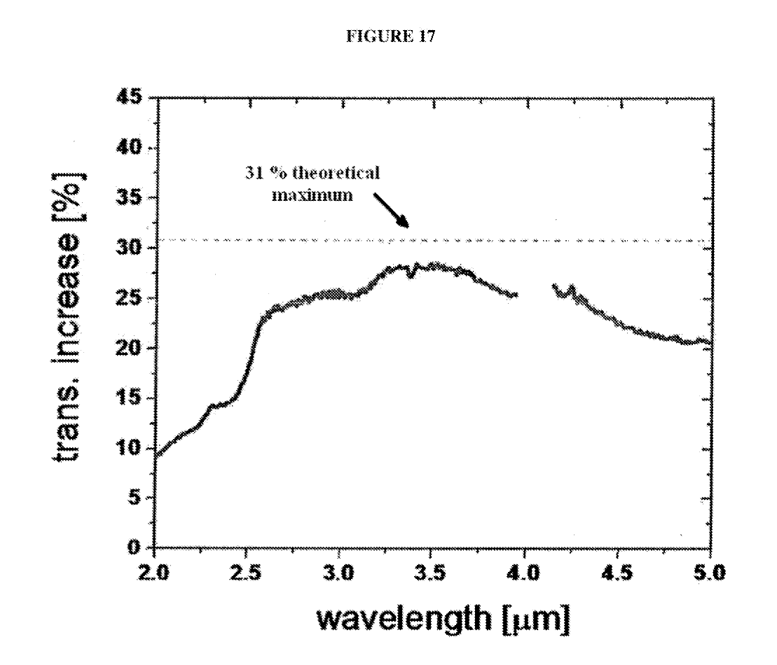

The transmission of an infrared As₂S₃ optical fiber with a motheye structure formed on both of its terminal ends was investigated. FIG. 17 shows a graph demonstrating a 31% improvement in transmission. Transmission loss was reduced from 31% to about 3%. Upon optimization of the motheye structure, it is believed to be further possible to reduce transmission loss to 0.1%. Furthermore, the transmission loss was reduced over large bandwidths from about 2 μm to about 5 μm. Reductions over wider bandwidths may be achieved by optimizing the design. The optical fiber also was compatible with high power laser handling greater than 1 GW/cm².

It is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. An optical fiber comprising:
an elongated body and
a terminal end having a plurality of microstructures selected from the group consisting of protrusions, recesses and combinations thereof, defined on or in a surface of said terminal end, said optical fiber being capable of transmitting light over at least a portion of an infrared wavelength range.

2. The optical fiber of claim 1, wherein said protrusions or said recesses have a configuration selected from the group consisting of flat top pyramids, pointed top pyramids, cones, semi-circular domes, sinusoidal-shaped domes, sigmoid profiles, tapered structures having a multi-faceted apex, cones of quintic profiles and combinations thereof.

3. The optical fiber of claim 1, wherein said elongated body comprises a core and a cladding disposed about said core, and said core or said cladding comprises a material selected from the group consisting of chalcogenide glass and fluoride glass.

4. The optical fiber of claim 1, wherein each of said plurality of microstructures are identical and wherein said plurality of microstructures are periodically arranged in rows on said surface of said terminal end.

5. The optical fiber of claim 4, wherein a period of a row or column of said microstructures is up to about and including λ.

6. The optical fiber of claim 4, wherein a period of a rows or column of said microstructures is from about λ/2n to about λ, where n is the index of refraction of a core of said optical fiber.

7. The optical fiber of claim 4, wherein a height or depth-to-period aspect ratio of said microstructures is about n, where n is the index of refraction of the material used to fabricate the microstructures.

8. The optical fiber of claim 1, wherein two or more of said microstructures have a different height or depth and are randomly arranged on said surface of said terminal end.

9. The optical fiber of claim 8, wherein each of said microstructures has a height or depth within a range of about 100 nm to about 2 um.

10. The optical fiber of claim 8, wherein each of said microstructures are separated by a distance within a range of about 50 nm to about 800 nm.

11. The optical fiber of claim 1, further comprising a transparent cover associated with an outer sheath of said optical fiber that encloses and is spaced apart from said terminal end.

12. The optical fiber of claim 11, wherein a surface of said transparent cover, positioned for transmission or manipulation of light to said terminal end, has a curved configuration.

13. The optical fiber of claim 11, further comprising an optic positioned for transmission or manipulation of light to said terminal end and coupled to said transparent cover or said sheath.

14. The optical fiber of claim 1, wherein the optical fiber has a higher transmission in the infrared than an identical fiber without the microstructures on the terminal end thereof.

15. An optical fiber comprising:
an elongated body and
a terminal end having a plurality of microstructures selected from the group consisting of protrusions, recesses and combinations thereof, directly formed on or in a surface of said terminal end to provide an effective incremental change in the refractive index along a length of the microstructures extending from the terminal end to an apex of said microstructure of from about 1 to about 3.

16. The optical fiber of claim 15, wherein said protrusions or said recesses have a configuration selected from the group consisting of flat top pyramids, pointed top pyramids, cones, semi-circular domes, sinusoidal-shaped domes, sigmoid profiles, tapered structures having a multi-faceted apex, cones of quintic profiles and combinations thereof.

17. The optical fiber of claim 15, further comprising a transparent cover associated with an outer sheath of said optical fiber that encloses and is spaced apart from said terminal end.

18. The optical fiber of claim 15, wherein a surface of said cover positioned opposite to said terminal end has a curved configuration.

19. The optical fiber of claim 17, further comprising an optic positioned opposite to said terminal end and coupled to said transparent cover or said sheath.

20. A method for enhancing the transmission of light at the interface of an optical fiber, wherein the method comprises forming a plurality of microstructures directly onto the terminal end of the optical fiber, wherein the microstructures incrementally change the refractive index of the terminal end, drawing it closer to the refractive index of the environmental medium surrounding said terminal end of the optical fiber.

21. The method of claim 20, wherein formation of said plurality of microstructures is achieved by a method selected from the group consisting of: lithography, reactive ion etching, ion milling, embossing and stamping.
